(19) United States
(12) Patent Application Publication
(10) Pub. No.: US 2026/0112231 A1
(43) Pub. Date: Apr. 23, 2026

(54) MONITORING SUSTAINABILITY IN A GAMING ENVIRONMENT

(71) Applicant: IGT, Las Vegas, NV (US)

(72) Inventor: Dwayne Nelson, Las Vegas, NV (US)

(21) Appl. No.: 18/923,415

(22) Filed: Oct. 22, 2024

(51) Int. Cl. G07F 17/32

(52) U.S. Cl. CPC G07F 17/3227; G07F 17/3211; G07F 17/323; G07F 17/3237

(57) ABSTRACT

Embodiments are directed to monitoring sustainability in a gaming environment. For example, embodiments can measure the energy savings or environmental impact of gaming systems such as Electronic Gaming Machines (EGMs), Video Lottery Terminals (VLT), or sports wagering play in casinos, show players which methods of play are saving energy, and then offers players incentives to save energy. For example, players who choose to turn down the brightness of the gaming system display might be awarded additional player club points for being “green.” Various embodiments described herein can include, but are not limited to, calculating the energy used by a gaming system, displaying the energy used by the play of the gaming system or its impact on sustainability, incentivizing the player to use sustainable features of the gaming system, i.e., energy saving features, rewarding the player for sustainable play including additional player points or “Green” player points, and/or others.

### BACKGROUND

The present disclosure is generally directed to monitoring environmental sustainability and more particularly to monitoring sustainability in a gaming environment.

Generally speaking, sustainability is the use of resources in a manner that meets current needs while maintaining sufficient resources to satisfy future needs as well. Sustainability is a growing concern and goal of many businesses and organizations in a wide range of industries. For example, casinos and other gaming venues use large amounts of electricity, water, and other resources in their daily operations. Monitoring the use of these resources so that the use may be controlled not only helps to address sustainability concerns but can help to control operating expenses for the casino or gaming venue.

### BRIEF SUMMARY

Embodiments of the present disclosure are directed to monitoring sustainability in a gaming environment. According to one embodiment, a system can comprise a communication network and a gaming system coupled with the communication network. The gaming system can comprise a display device, a processor coupled with the display device, and a memory coupled with and readable by the processor. The memory can store therein a set of instructions which, when executed by the processor, causes the processor to present, through the display device, a menu of choices for an electronic game executing on the gaming system. The menu of choices can comprise a plurality of selectable options for the electronic game, and each selectable option can be associated with a sustainability level. The plurality of selectable options can comprise any one or more of an option related to a theme for the electronic game, an option related to a feature of the electronic game, an option related to use of hardware of the gaming system, and/or other options. The instructions can further cause the processor to present, through the display device, a sustainability indicator for the plurality of choices based on the sustainability level associated with each selectable option of the plurality of selectable options, receive a selection of a player of the electronic game of a selected option of the plurality of selectable options, and provide, through the communications network, an electronic message identifying the player and the selected option.

The system can further comprise a sustainability monitoring system coupled with the communication network. The sustainability monitoring system can comprise a processor and a memory coupled with and readable by the processor of the sustainability monitoring system. The memory of the sustainability monitoring system can store therein a set of instructions which, when executed by the processor of the sustainability monitoring system, can causes the processor of the sustainability monitoring system to receive, through the communications network, the electronic message from the gaming system, update a player sustainability record for the player identified in the electronic message based on the selected option identified in the electronic message, and determine based on the sustainability record for the player, whether to provide a sustainability reward to the player. In response to determining to provide the sustainability reward to the player, the instructions stored in the memory of the sustainability monitoring system can cause the processor of the sustainability monitoring system to provide, through the communications network, an electronic message indicating the sustainability reward.

For example, providing, through the communications network, the electronic message indicating the sustainability reward by the sustainability management system can comprise providing the electronic message to a mobile device of the player. In another example, the sustainability reward can comprise access to a feature of the electronic game and the instructions stored in the memory of the gaming system can further cause the gaming system to receive, through the communications network, the electronic message indicating the sustainability reward from the sustainability management system and provide, to the player, in the electronic game, access to the feature of the electronic game.

In some cases, the instructions stored in the memory of the sustainability management system can further cause the processor of the sustainability management system to determine, based on the sustainability record for the player, a sustainability level for the player relative to a plurality of players and provide, through the communications network, an electronic message indicating the sustainability level for the player. In such cases, the instructions stored in the memory of the gaming system can further cause the gaming system to receive, through the communications network, the electronic message indicating the sustainability level for the player and provide, to the player, through the display device an indication of the sustainability level for the player.

According to another embodiment, a system can comprise a communication network and a gaming system of a gaming venue coupled with the communication network. The gaming system can comprise a processor and a memory coupled with and readable by the processor. The memory can store therein a set of instructions which, when executed by the processor, causes the processor to execute an electronic game, monitor usage of the gaming system by a player of the electronic game, and provide, through the communications network, an electronic message identifying the player and the information indicating the usage of the gaming system by the player of the electronic game.

The system can further comprise a sustainability monitoring system coupled with the communication network. The sustainability monitoring system can comprise a processor and a memory coupled with and readable by the processor of the sustainability monitoring system. The memory of the sustainability monitoring system can store therein a set of instructions which, when executed by the processor of the sustainability monitoring system, causes the processor to of the sustainability monitoring system receive, through the communications network, the electronic message from the gaming system, update a player sustainability record for the player identified in the electronic message based on the usage of the gaming system by the player identified in the electronic message, determine based on the sustainability record for the player, whether to provide a sustainability reward to the player, and in response to determining to provide the sustainability reward to the player, provide, through the communications network, an electronic message indicating the sustainability reward.

In some cases, the system can further comprise a restaurant management system comprising a processor and a memory coupled with and readable by the processor of the restaurant management system. The memory of the restaurant management system can store therein a set of instructions which, when executed by the processor of the restaurant management system, causes the processor of the restaurant management system to monitor usage of a restaurant of the gaming venue by the player and provide, through the communications network, to the sustainability monitoring system, an electronic message comprising information indicating the usage of the restaurant by the player. In such cases, the instructions stored in the memory of the sustainability monitoring system further cause the processor of the sustainability monitoring system to update the player sustainability record based on the information indicating the usage of the restaurant by the player.

Additionally, or alternatively, the system can comprise a housekeeping management system comprising a processor and a memory coupled with and readable by the processor of the housekeeping management system. The memory of the housekeeping management system can store therein a set of instructions which, when executed by the processor of the housekeeping management system, causes the processor of the housekeeping management system to monitor usage of a housekeeping services of a hotel of the gaming venue by the player and provide, through the communications network, to the sustainability monitoring system, an electronic message comprising information indicating the usage of the housekeeping services by the player. In such cases, the instructions stored in the memory of the sustainability monitoring system can further cause the processor of the sustainability monitoring system to update the player sustainability record based on the information indicating the usage of the housekeeping service the player.

The system can additionally, or alternatively, comprise a spa system comprising a processor and a memory coupled with and readable by the processor of the spa system. The memory of the spa system can store therein a set of instructions which, when executed by the processor of the spa system, causes the processor of the spa system to monitor usage of services of a of the gaming venue by the player and provide, through the communications network, to the sustainability monitoring system, an electronic message comprising information indicating the usage of the services of the spa by the player. In such cases, the instructions stored in the memory of the sustainability monitoring system can further cause the processor of the sustainability monitoring system to update the player sustainability record based on the information indicating the usage of the services of the spa by the player.

Additionally, or alternatively, the system can further comprise an online gaming system providing online access to the electronic game executed by the gaming system. The online gaming system can comprise a processor and a memory coupled with and readable by the processor of the online gaming system. The memory of the online gaming system can store therein a set of instructions which, when executed by the processor of the online gaming system, causes the processor of the online gaming system to monitor access of the electronic game by the player through the online gaming system and provide, through the communications network, to the sustainability monitoring system, an electronic message comprising information indicating the access of the electronic game by the player through the online gaming system. In such cases, the instructions stored in the memory of the sustainability monitoring system can further cause the processor of the sustainability monitoring system to update the player sustainability record based on the information indicating the access of the electronic game by the player through the online gaming system.

In some cases, providing, through the communications network, the electronic message indicating the sustainability reward by the sustainability management system can comprise providing the electronic message to a mobile device of the player. Additionally, or alternatively, providing, through the communications network, the electronic message indicating the sustainability reward by the sustainability management system can comprise providing the electronic message to the gaming system. In such cases, the instructions stored in the memory of the gaming system can further cause the processor of the gaming system to receive the electronic message from the sustainability management system through the communications network and provide, to the player, through the display device, an indication of the sustainability reward.

According to yet another embodiment, a gaming system can comprise a communications interface, a display device, a processor coupled with the communications interface and the display device, and a memory coupled with and readable by the processor. The memory can store therein a set of instructions which, when executed by the processor, causes the processor to present, through the display device, a menu of choices for an electronic game executing on the gaming system. The menu of choices can comprise a plurality of selectable options for the electronic game, and each selectable option can associated with a sustainability level. The plurality of selectable options can comprise any one or more of an option related to a theme for the electronic game, an option related to a feature of the electronic game, an option related to use of hardware of the gaming system, and/or other options.

The instructions can further cause the processor to present, through the display device, a sustainability indicator for the plurality of choices based on the sustainability level associated with each selectable option of the plurality of selectable options, receive a selection of a player of the electronic game of a selected option of the plurality of selectable options, provide, through the communications network, to a sustainability monitoring system, an electronic message identifying the player and the selected option, execute the electronic game, monitor usage of the gaming system by the player of the electronic game, and provide, through the communications network, to the sustainability monitoring system, an electronic message identifying the player and the information indicating the usage of the gaming system by the player of the electronic game.

The instructions can further cause the processor to receive, through the communications interface, from the sustainability monitoring system, an electronic message comprising information indicating a sustainability reward for the player based on the selected option and the usage of the gaming system by the player and present, through the display device, an indication of the sustainability reward. For example, the sustainability reward can comprise access to a feature of the electronic game. In such cases, the instructions stored in the memory of the gaming system can further cause the gaming system to provide, to the player, in the electronic game, access to the feature of the electronic game.

Additional features and advantages are described herein and will be apparent from the following Description and the figures.

### BRIEF DESCRIPTION OF THE SEVERAL VIEWS OF THE DRAWINGS

FIG. 1 is a block diagram illustrating an exemplary environment in which embodiments of the present disclosure may be implemented.

FIG. 2 is a block diagram illustrating additional details of components of an exemplary sustainability monitoring system according to one embodiment of the present disclosure.

FIG. 3 is a block diagram illustrating additional details of components of an exemplary gaming system according to one embodiment of the present disclosure.

FIG. 4 is a block diagram illustrating additional details of components of an exemplary facilities system according to one embodiment of the present disclosure.

FIG. 5 is a flowchart illustrating an exemplary process for monitoring sustainability in a gaming environment according to one embodiment of the present disclosure.

FIG. 6 is a flowchart illustrating an exemplary process for monitoring sustainability in a gaming environment according to another embodiment of the present disclosure.

FIG. 7 is a flowchart illustrating an exemplary process for monitoring sustainability in a gaming environment according to another embodiment of the present disclosure.

FIG. 8 is a flowchart illustrating an exemplary process for monitoring sustainability in a gaming environment according to another embodiment of the present disclosure.

### DETAILED DESCRIPTION

Embodiments of the present disclosure are directed to monitoring sustainability in a gaming environment. For example, embodiments can measure the energy savings or environmental impact of gaming systems such as Electronic Gaming Machines (EGMs), Video Lottery Terminals (VLT), or sports wagering play in casinos, show players which methods of play are saving energy, and then offers players incentives to save energy. For example, players who choose to turn down the brightness of the gaming system display might be awarded additional player club points for being “green.” Various embodiments described herein can include, but are not limited to, calculating the energy used by a gaming system, displaying the energy used by the play of the gaming system or its impact on sustainability, incentivizing the player to use sustainable features of the gaming system, i.e., energy saving features, rewarding the player for sustainable play including additional player points or “Green” player points, and/or others.

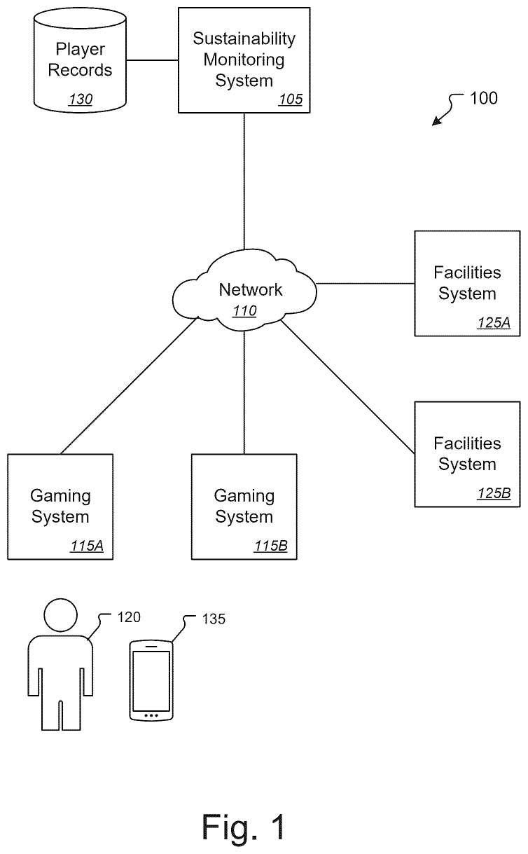

FIG. 1 is a block diagram illustrating an exemplary environment in which embodiments of the present disclosure may be implemented. As illustrated in this example, the environment 100 can comprise a sustainability monitoring system 105 coupled with a communications network 110. The sustainability monitoring system 105 can comprise any one or more servers and/or other computing devices as known in the art. The communications network 110 can comprise any one or more wired and/or wireless, local-area and/or wide-area networks as known in the art including, but not limited to, the Internet.

Also coupled with the communications network 110 can be any one or more gaming systems 115A-115B. Each gaming system 115A-115B can comprise, for example, any Electronic Gaming Machine (EGM), kiosk, or similar gaming system as may be found in a casino or other gaming venue. The gaming systems 115A-115B can each execute any of a variety of electronic games including, but not limited to slots, video slots, video poker, keno, etc.

Also coupled with the communications network 110 can be any one or more facilities systems 125A-125B. Generally speaking, the facilities systems 125A-125B can each comprise any one or more servers and/or other computing devices as known in the art and which can be used to monitor and/or manages various facilities and/or services of a casino or other gaming venue. For example, the facilities systems 125A-125B can comprise one or more restaurant management systems monitoring and/or managing orders and/or other usage of one or more restaurants within or associated with the casino or gaming venue. Additionally, or alternatively, the facilities systems 125A-125B can comprise one or more housekeeping management systems monitoring and/or managing housekeeping services of one or more hotels within or associated with the casino or gaming venue. The facilities systems 125A-125B can additionally, or alternatively, comprise one or more spa systems monitoring and/or managing spa services and/or other usage of one or more spas within or associated with the casino or gaming venue. Additionally, or alternatively, the facilities systems 125A-125B can comprise one or more online gaming systems providing online access to electronic games such as those available in a physical casino or gaming venue.

According to one embodiment, the gaming systems 115A-115B can determine the power usage of game play. This can be achieved in many ways. In one embodiment, the gaming system can a power meter to measure its electricity usage. The power meter could be wired to the gaming system electronics or use wireless technology such as Bluetooth or WIFI. In either case the gaming system software can measure the real time electricity usage of the all or part of the cabinet.

In another embodiment, the gaming system can maintain a database of power usage such as the average power usage of Game Theme A and Game Theme B. This database can be located within each game package or available on a host, such as the sustainability monitoring system 105. The database could be Watts per unit of time, but in other embodiments, the database can be more complex and represent the power usage of the game in different configurations.

In one embodiment, the gaming system can show the player the amount of energy a game uses in a game chooser menu. This allows the player to decide if they want to pick a certain theme. The amount of energy could be a range for games that uses a different amount of energy per configuration. In one embodiment, the exact usage is not used but a relative or objective description such as “most efficient” or “better than average” indication can be provided. Colors or fonts can be used also such that energy efficient themes use green colors while energy inefficient themes use red colors, for example. An icon can also be used for “green” games.

Power measurements can be in watts per unit of time, but in other embodiments the units can be money, number of trees planted or saved, number of whales saved, pounds of carbon or carbon dioxide, carbon dioxide usage, etc. In these alternate embodiments the gaming system can convert power into the alternate units. In one embodiment, the operator can enter the conversion rate into the gaming system or sustainability monitoring system 105 system. The units can be units of energy used or units of energy saved. The savings can be from the player options, e.g., player lowers the screen brightness, or the savings can be from the comparison to other players, e.g., player is using less energy than the average player.

The sustainability monitoring system 105 can receive information related to the game play, or energy usage of each gaming system 115A-115B to determine the average usage. For example, the sustainability monitoring system 105 could query the gaming system to learn that player Bob has played for 1 hour and has used 13.2 kilowatts. In another example, the sustainability monitoring system 105 could query the gaming system to learn that Bob has played for 1 hour and the sustainability monitoring system 105 can maintain a database of games (like the gaming system described before) and the sustainability monitoring system 105 can calculate the energy usage of the 1 hour.

The displays can also be show in energy savings instead of energy used. This can be combined with an embodiment where the player has chosen an energy efficient game or has chosen an energy efficient configuration.

Through a menu of selections presented by the gaming system, the player might choose monitor configurations, lighting configurations, graphics settings (frame rate, video capabilities, etc.), integrated vs dedicated GPU, peripherals, screen brightness, volume, etc.

In one embodiment the player can opt into or out of this feature. When a player opts into the feature, the system might indicate that the player is “green” such as on the top monitor. The display might show which options the player has chosen, how much they are saving or how much they have saved over time.

In one embodiment, the amount of player club points earned can be corelated to the energy usage such that players who save energy earn more player points. The number of player points earned could be a table or formula such that the player earns more points, the more they save. In one embodiment, players who save energy can earn a separate player point units such as an “Energy Point.” The energy point total can be shown on the player for status. In some cases, the player can use these “Energy Points” to purchase items or services much like player points. This would allow the casino to offer special awards, gifts or incentives to these players.

In one embodiment, the player can donate the Energy Points to a green charity.

In one embodiment, the energy savings can used to plants trees or perform some other environmental charitable activities. For example, the casino could donate to a charity that plants trees at the rate of 1 tree per 1K saved by all players.

In one embodiment, the reward for green players can be a drawing. In such cases, players saving a certain amount of energy can be eligible for a drawing. For example, players saving more than 10 Watts this week can be eligible for a drawing for a buffet ticket.

In one embodiment, green players can be permitted to unlock different bonuses, progressives, denominations, paytables, etc. In the progressive embodiment, the casino could have an “Energy Savers” progressive controller and only eligible “green” players can win that progressive.

According to one embodiment, an environmental impact can be assigned to build or retire a cabinet. The materials used to build the cabinet and the shipping of the cabinet to the casino can be quantified in terms of some impact on the environment. To retire a cabinet, the cabinet must be shipped and disposed of. This can also be measured.

In one embodiment, the player can be incentivized to play older cabinets. The display can show the player how much energy or environmental impact is happening from not using a new cabinet, but rather using an older cabinet.

As an example, the casino has new cabinet and old cabinets. When the player chooses to play the older cabinet, the player can receive additional player points or Energy Points.

As another example, the service window on an older gaming system could show “Keeping this gaming system on the floor saves XXXX trees”.

In one embodiment the casino can be an online casino. The online casino can calculate the energy saved by the player staying at home and not visiting a physical casino. The sustainability monitoring system 105 can determine where the player is playing and the location of one or more casinos to calculate the gas or other resources saved by the player staying at home. The sustainability monitoring system 105 can also compare the energy used by the online system vs the energy used by the gaming systems in the physical casino. In one embodiment the sustainability monitoring system 105 can also compute the cost to run the casino such as the lighting, air conditioning, etc. when comparing to the player staying at home.

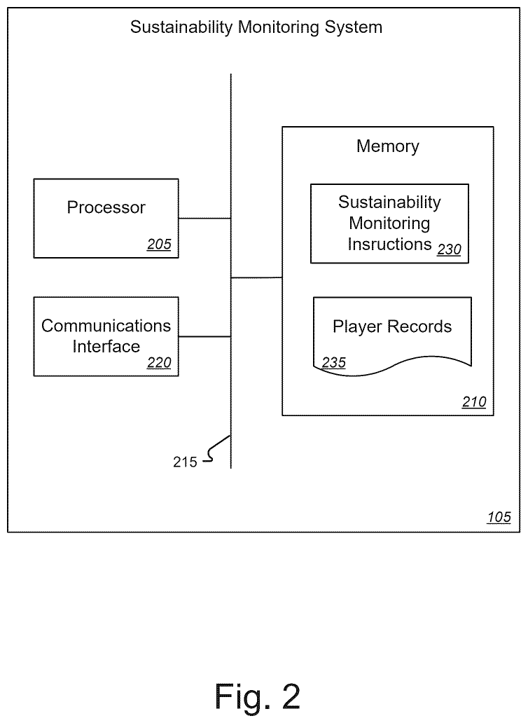

FIG. 2 is a block diagram illustrating additional details of components of an exemplary sustainability monitoring system according to one embodiment of the present disclosure. As illustrated in this example, a sustainability monitoring system 105 such as described above can comprise a processor 205. The processor 205 may correspond to one or many computer processing devices. For instance, the processor 205 may be provided as silicon, as a Field Programmable Gate Array (FPGA), an Application-Specific Integrated Circuit (ASIC), any other type of Integrated Circuit (IC) chip, a collection of IC chips, or the like. As a more specific example, the processor 205 may be provided as a microprocessor, Central Processing Unit (CPU), or plurality of microprocessors that are configured to execute the instructions sets stored in a memory 210. Upon executing the instruction sets stored in memory 210, the processor 205 enables various functions of the sustainability monitoring system 105 as described herein.

The memory 210 can be coupled with and readable by the processor 205 via a communications bus 215. The memory 210 may include any type of computer memory device or collection of computer memory devices. Non-limiting examples of memory 210 include Random Access Memory (RAM), Read Only Memory (ROM), flash memory, Electronically-Erasable Programmable ROM (EEPROM), Dynamic RAM (DRAM), etc. The memory 210 may be configured to store the instruction sets depicted in addition to temporarily storing data for the processor 205 to execute various types of routines or functions.

The processor 205 can also be coupled with one or more communication interface(s) 220 via the communications bus 215 and one or more sensors 225. The communication interface(s) 220 can comprise, for example, an Ethernet, Bluetooth, WiFi, cellular, and/or other type of wired and/or wireless communications interface. Via the communication interface(s) 220, the sustainability monitoring system 105 can communicate with other devices and/or systems through a communications network 110 as described above.

The memory 210 can store therein a set of sustainability monitoring instructions 230 which, when executed by the processor 205, cause the processor 205 to receive, through the communications interface 220, electronic messages containing game selection information, game usage information, facilities usage information, etc., from a gaming system 115A, a facilities system 125A, and or other systems, update a player sustainability record 235 for the player identified in the electronic messages based on the selected option identified in the electronic message, and determine based on the sustainability record for the player, whether to provide a sustainability reward to the player. In response to determining to provide the sustainability reward to the player, the sustainability monitoring instructions 230 can cause the processor 205 of the sustainability monitoring system 105 to provide, through the communications interface 220, an electronic message indicating the sustainability reward.

For example, providing, through the communications interface 220, the electronic message indicating the sustainability reward by the sustainability management system 105 can comprise providing the electronic message to a mobile device 135 of the player 120. In another example, the sustainability reward can comprise access to a feature of the electronic game and the sustainability monitoring instructions 230 can further cause the processor 205 to provide an electronic message to the gaming system 115A indicating that access to the feature should be granted. In some cases, the sustainability monitoring instructions 230 can further cause the processor 205 of the sustainability management system 105 to determine, based on the sustainability record 235 for the player 120, a sustainability level for the player 120 relative to a plurality of players and provide, through the communications interface 220, an electronic message indicating the sustainability level for the player 120.

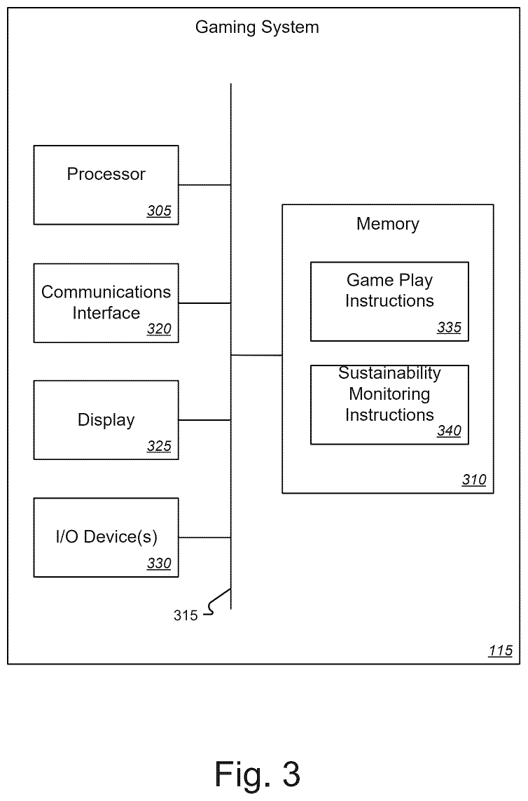

FIG. 3 is a block diagram illustrating additional details of components of an exemplary gaming system according to one embodiment of the present disclosure. As illustrated in this example, a gaming system 115 can comprise a processor 305 such as any of the various types of processors described above. A memory 310 can be coupled with and readable by the processor 305 via a communications bus 315. The memory 310 can comprise any one or more of the different types of volatile and/or non-volatile memories described above. The processor 305 can also be coupled with one or more communication interfaces 320, a display 325, and/or one or more input/output devices 3330. The communication interfaces 320 can comprise, for example, an Ethernet, Bluetooth, WiFi, cellular, and/or other type of wired and/or wireless communications interface. The display 325 can comprise a Liquid Crystal Display (LCD), Light Emitting Diode (LED), Organic Light Emitting Diode (OLED), or other type of display. The input/output devices 330 can include, but are not limited to, buttons, speakers, a ticket printer, one or more cameras, microphones, etc.

The memory 310 can store therein a set of game play instructions 335 which, when executed by the processor 305, causes the processor to execute an electronic game including, but not limited to slots, video slots, video poker, keno, etc. The memory 310 can also store therein a set of sustainability monitoring instructions 340 which, when executed by the processor 305, causes the processor 305 to present, through the display device 325, a menu of choices for an electronic game executing on the gaming system. The menu of choices can comprise a plurality of selectable options for the electronic game, and each selectable option can be associated with a sustainability level. The plurality of selectable options can comprise any one or more of an option related to a theme for the electronic game, an option related to a feature of the electronic game, an option related to use of hardware of the gaming system, and/or other options. The sustainability monitoring instructions 340 can further cause the processor 320 to present, through the display device, a sustainability indicator for the plurality of choices based on the sustainability level associated with each selectable option of the plurality of selectable options, receive, e.g., through an input device 330, a selection of a player 120 of the electronic game of a selected option of the plurality of selectable options, and provide, through the communications interface 320, an electronic message identifying the player and the selected option. Additionally, or alternatively, the sustainability monitoring instructions 340 can cause the processor 305 to monitor usage of the gaming system 115 by a player 120 of the electronic game, and provide, through the communications interface 320, an electronic message identifying the player and the information indicating the usage of the gaming system by the player of the electronic game.

According to one embodiment, the sustainability monitoring instructions 340 can cause the processor 305 to receive, through the communications interface 320, the electronic message indicating a sustainability reward from the sustainability management system 105 and provide, to the player 120, an indication of the reward. In some cases, the reward can comprise access to a game feature of the electronic game. In such cases, the sustainability monitoring instructions 340 can cause the processor 305 to provide access to the game feature in the executing electronic game. Additionally, or alternatively, the sustainability monitoring instructions 340 can further cause the processor 305 to receive, through the communications interface 320, an electronic message indicating the sustainability level for the player 120 and provide, to the player 120, through the display device 325 an indication of the sustainability level for the player 120.

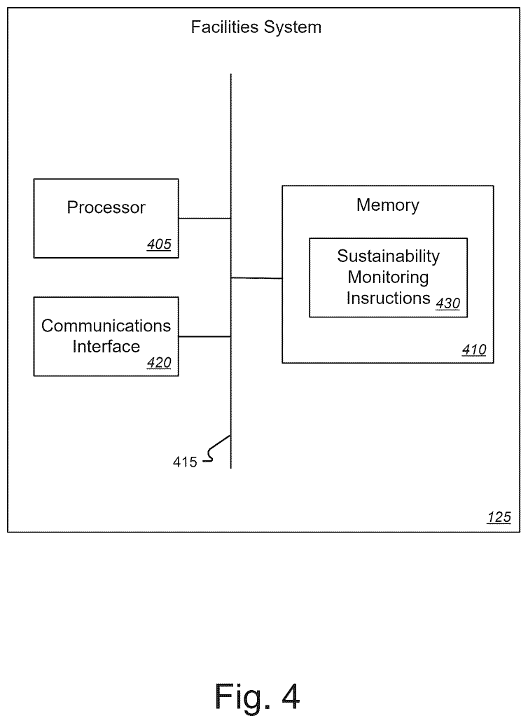

FIG. 4 is a block diagram illustrating additional details of components of an exemplary facilities system according to one embodiment of the present disclosure. As illustrated in this example, a facilities system 125, such as a restaurant management system, housekeeping management system, spa system, online gaming system, etc., can comprise a processor 405 such as any of the various types of processors described above. A memory 410 can be coupled with and readable by the processor 405 via a communications bus 415. The memory 410 can comprise any one or more of the different types of volatile and/or non-volatile memories described above. The processor 405 can also be coupled with one or more communication interfaces 420. The communication interfaces 420 can comprise, for example, an Ethernet, Bluetooth, WiFi, cellular, and/or other type of wired and/or wireless communications interface.

The memory 410 can store therein a set of sustainability monitoring instructions 430 which, when executed by the processor 405, causes the processor to monitor usage of a facility of the gaming venue by the player 120 and provide, through the communications interface 420, to the sustainability monitoring system 105, an electronic message comprising information indicating the usage by the player.

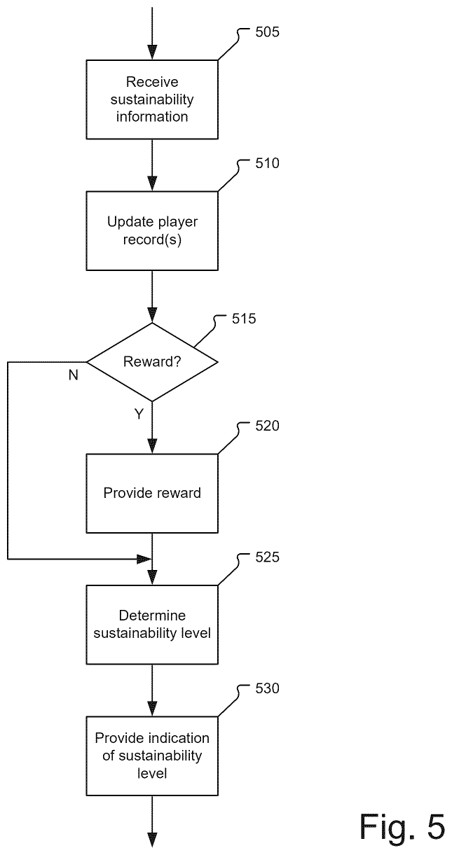

FIG. 5 is a flowchart illustrating an exemplary process for monitoring sustainability in a gaming environment according to one embodiment of the present disclosure. More specifically, this example illustrates processes as may be performed by a sustainability monitoring system 105 as described above. As illustrated in this example, monitoring sustainability can comprise receiving 505 an electronic message containing game selection information, game usage information, facilities usage information, etc., from a gaming system 115A, a facilities system 125A, and or other systems. A player sustainability record 235 for the player 120 identified in the electronic message can be updated 510 based on the selected option and/or usage information identified in the electronic message. A determination 515 can be made based on the sustainability record for the player as to whether to provide a sustainability reward to the player. In response to determining 515 to provide the sustainability reward to the player, an electronic message indicating the sustainability reward can be provided 520, e.g., through the player's mobile device 135, the gaming system 115, etc. Additionally, or alternatively, a sustainability level for the player 120 relative to a plurality of players can be determined 525 based on the sustainability record 235 for the player 120. An electronic message indicating the sustainability level can be provided 530 to the player 120, e.g., through the player's mobile device 135, the gaming system 115, etc.

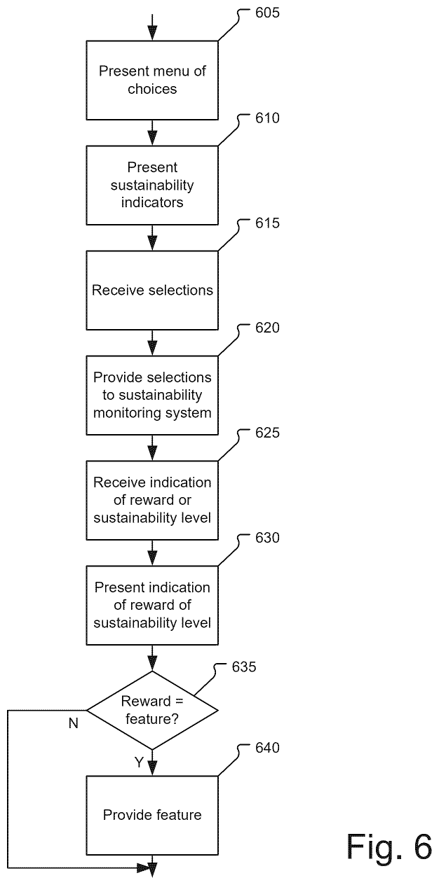

FIG. 6 is a flowchart illustrating an exemplary process for monitoring sustainability in a gaming environment according to another embodiment of the present disclosure. More specifically, this example illustrates processes as may be performed by a gaming system 115 as described above. As illustrated in this example, monitoring sustainability can comprise presenting 605 a menu of choices for an electronic game executing on the gaming system. The menu of choices can comprise a plurality of selectable options for the electronic game, and each selectable option can be associated with a sustainability level. The plurality of selectable options can comprise any one or more of an option related to a theme for the electronic game, an option related to a feature of the electronic game, an option related to use of hardware of the gaming system, and/or other options. A sustainability indicator for the plurality of choices based on the sustainability level associated with each selectable option of the plurality of selectable options can also be presented 610. A selection of a player 120 of the electronic game can be received 615 indicating one or more selected options of the plurality of selectable options. An electronic message identifying the player and the selected option(s) can be provided 620 to the sustainability monitoring system 105.

At some point in time, an electronic message indicating a sustainability reward and/or a sustainability level for the player 120 can be received 625 from the sustainability management system 105. An indication of the reward and/or sustainability level can be presented 630 to the player. In some cases, the reward can comprise access to a game feature. Accordingly, a determination 635 can be made as to whether the reward is access to a game feature. In response to determining 635 that the reward is access to a game feature, access to the game feature can be provided 640 in the executing electronic game.

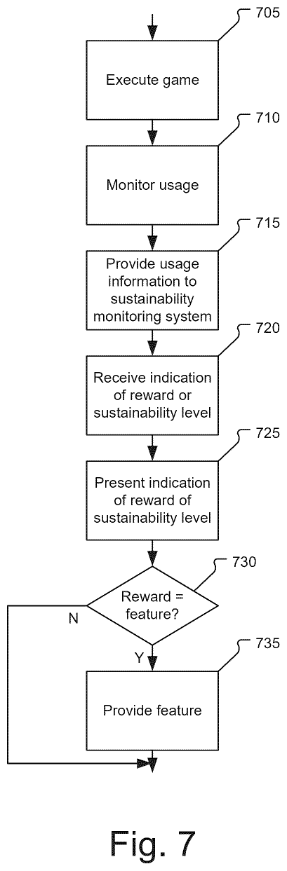

FIG. 7 is a flowchart illustrating an exemplary process for monitoring sustainability in a gaming environment according to another embodiment of the present disclosure. More specifically, this example illustrates processes as may be performed by a gaming system 115 as described above. As illustrated in this example, monitoring sustainability can comprise executing 705 an electronic game and monitoring 710 usage of the gaming system 115 by a player 120 of the electronic game. An electronic message identifying the player and the information indicating the usage of the gaming system by the player of the electronic game can be provided 715 to the sustainability monitoring system 105.

At some point in time, an electronic message indicating a sustainability reward and/or a sustainability level for the player 120 can be received 720 from the sustainability management system 105. An indication of the reward and/or sustainability level can be presented 725 to the player. In some cases, the reward can comprise access to a game feature. Accordingly, a determination 730 can be made as to whether the reward is access to a game feature. In response to determining 730 that the reward is access to a game feature, access to the game feature can be provided 735 in the executing electronic game.

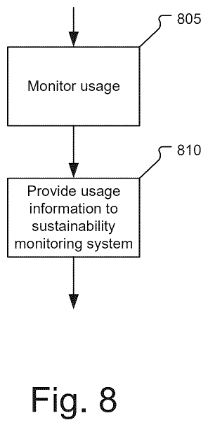

FIG. 8 is a flowchart illustrating an exemplary process for monitoring sustainability in a gaming environment according to another embodiment of the present disclosure. More specifically, this example illustrates processes as may be performed by a facilities system 125 as described above. As illustrated in this example, monitoring sustainability can comprise monitoring 805 usage of a facility of the gaming venue by the player 120. An electronic message comprising information indicating the facility usage by the player 120 can be provided 810 to the sustainability monitoring system 105. For example, the usage information can indicate usage of a restaurant, e.g., use of reusage utensils and other items rather than disposable ones, usage of housekeeping services, e.g., numbers of towels used etc., usage of a spa, e.g., use of towels, a shower, etc., usage of an online gaming system, e.g., rather than traveling to a physical casino or gaming venue, etc.

A number of variations and modifications of the disclosure can be used. It would be possible to provide for some features of the disclosure without providing others.

The present disclosure contemplates a variety of different gaming systems each having one or more of a plurality of different features, attributes, or characteristics. A “gaming system” as used herein refers to various configurations of: (a) one or more central servers, central controllers, or remote hosts; (b) one or more electronic gaming machines such as those located on a casino floor; and/or (c) one or more personal gaming devices, such as desktop computers, laptop computers, tablet computers or computing devices, personal digital assistants, mobile phones, and other mobile computing devices. Moreover, an EGM as used herein refers to any suitable electronic gaming machine which enables a player to play a game (including but not limited to a game of chance, a game of skill, and/or a game of partial skill) to potentially win one or more awards, wherein the EGM comprises, but is not limited to: a slot machine, a video poker machine, a video lottery terminal, a terminal associated with an electronic table game, a video keno machine, a video bingo machine located on a casino floor, a sports betting terminal, or a kiosk, such as a sports betting kiosk.

In various embodiments, the gaming system of the present disclosure includes: (a) one or more electronic gaming machines in combination with one or more central servers, central controllers, or remote hosts; (b) one or more personal gaming devices in combination with one or more central servers, central controllers, or remote hosts; (c) one or more personal gaming devices in combination with one or more electronic gaming machines; (d) one or more personal gaming devices, one or more electronic gaming machines, and one or more central servers, central controllers, or remote hosts in combination with one another; (e) a single electronic gaming machine; (f) a plurality of electronic gaming machines in combination with one another; (g) a single personal gaming device; (h) a plurality of personal gaming devices in combination with one another; (i) a single central server, central controller, or remote host; and/or (j) a plurality of central servers, central controllers, or remote hosts in combination with one another.

For brevity and clarity and unless specifically stated otherwise, “EGM” as used herein represents one EGM or a plurality of EGMs, “personal gaming device” as used herein represents one personal gaming device or a plurality of personal gaming devices, and “central server, central controller, or remote host” as used herein represents one central server, central controller, or remote host or a plurality of central servers, central controllers, or remote hosts.

As noted above, in various embodiments, the gaming system includes an EGM (or personal gaming device) in combination with a central server, central controller, or remote host. In such embodiments, the EGM (or personal gaming device) is configured to communicate with the central server, central controller, or remote host through a data network or remote communication link. In certain such embodiments, the EGM (or personal gaming device) is configured to communicate with another EGM (or personal gaming device) through the same data network or remote communication link or through a different data network or remote communication link. For example, the gaming system includes a plurality of EGMs that are each configured to communicate with a central server, central controller, or remote host through a data network.

In certain embodiments in which the gaming system includes an EGM (or personal gaming device) in combination with a central server, central controller, or remote host, the central server, central controller, or remote host is any suitable computing device (such as a server) that includes at least one processor and at least one memory device or data storage device. As further described herein, the EGM (or personal gaming device) includes at least one EGM (or personal gaming device) processor configured to transmit and receive data or signals representing events, messages, commands, or any other suitable information between the EGM (or personal gaming device) and the central server, central controller, or remote host. The at least one processor of that EGM (or personal gaming device) is configured to execute the events, messages, or commands represented by such data or signals in conjunction with the operation of the EGM (or personal gaming device). Moreover, the at least one processor of the central server, central controller, or remote host is configured to transmit and receive data or signals representing events, messages, commands, or any other suitable information between the central server, central controller, or remote host and the EGM (or personal gaming device). The at least one processor of the central server, central controller, or remote host is configured to execute the events, messages, or commands represented by such data or signals in conjunction with the operation of the central server, central controller, or remote host. One, more than one, or each of the functions of the central server, central controller, or remote host may be performed by the at least one processor of the EGM (or personal gaming device). Further, one, more than one, or each of the functions of the at least one processor of the EGM (or personal gaming device) may be performed by the at least one processor of the central server, central controller, or remote host.

In certain such embodiments, computerized instructions for controlling any games (such as any primary or base games and/or any secondary or bonus games) displayed by the EGM (or personal gaming device) are executed by the central server, central controller, or remote host. In such “thin client” embodiments, the central server, central controller, or remote host remotely controls any games (or other suitable interfaces) displayed by the EGM (or personal gaming device), and the EGM (or personal gaming device) is utilized to display such games (or suitable interfaces) and to receive one or more inputs or commands. In other such embodiments, computerized instructions for controlling any games displayed by the EGM (or personal gaming device) are communicated from the central server, central controller, or remote host to the EGM (or personal gaming device) and are stored in at least one memory device of the EGM (or personal gaming device). In such “thick client” embodiments, the at least one processor of the EGM (or personal gaming device) executes the computerized instructions to control any games (or other suitable interfaces) displayed by the EGM (or personal gaming device).

In various embodiments in which the gaming system includes a plurality of EGMs (or personal gaming devices), one or more of the EGMs (or personal gaming devices) are thin client EGMs (or personal gaming devices) and one or more of the EGMs (or personal gaming devices) are thick client EGMs (or personal gaming devices). In other embodiments in which the gaming system includes one or more EGMs (or personal gaming devices), certain functions of one or more of the EGMs (or personal gaming devices) are implemented in a thin client environment, and certain other functions of one or more of the EGMs (or personal gaming devices) are implemented in a thick client environment. In one such embodiment in which the gaming system includes an EGM (or personal gaming device) and a central server, central controller, or remote host, computerized instructions for controlling any primary or base games displayed by the EGM (or personal gaming device) are communicated from the central server, central controller, or remote host to the EGM (or personal gaming device) in a thick client configuration, and computerized instructions for controlling any secondary or bonus games or other functions displayed by the EGM (or personal gaming device) are executed by the central server, central controller, or remote host in a thin client configuration.

In certain embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a local area network (LAN) in which the EGMs (or personal gaming devices) are located substantially proximate to one another and/or the central server, central controller, or remote host. In one example, the EGMs (or personal gaming devices) and the central server, central controller, or remote host are located in a gaming establishment or a portion of a gaming establishment.

In other embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a wide area network (WAN) in which one or more of the EGMs (or personal gaming devices) are not necessarily located substantially proximate to another one of the EGMs (or personal gaming devices) and/or the central server, central controller, or remote host. For example, one or more of the EGMs (or personal gaming devices) are located: (a) in an area of a gaming establishment different from an area of the gaming establishment in which the central server, central controller, or remote host is located; or (b) in a gaming establishment different from the gaming establishment in which the central server, central controller, or remote host is located. In another example, the central server, central controller, or remote host is not located within a gaming establishment in which the EGMs (or personal gaming devices) are located. In certain embodiments in which the communication network includes a WAN, the gaming system includes a central server, central controller, or remote host and an EGM (or personal gaming device) each located in a different gaming establishment in a same geographic area, such as a same city or a same state. Gaming systems in which the communication network includes a WAN are substantially identical to gaming systems in which the communication network includes a LAN, though the quantity of EGMs (or personal gaming devices) in such gaming systems may vary relative to one another.

In further embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include an internet (such as the Internet) or an intranet. In certain such embodiments, an Internet browser of the EGM (or personal gaming device) is usable to access an Internet game page from any location where an Internet connection is available. In one such embodiment, after the EGM (or personal gaming device) accesses the Internet game page, the central server, central controller, or remote host identifies a player before enabling that player to place any wagers on any plays of any wagering games. In one example, the central server, central controller, or remote host identifies the player by requiring a player account of the player to be logged into via an input of a unique player name and password combination assigned to the player. The central server, central controller, or remote host may, however, identify the player in any other suitable manner, such as by validating a player tracking identification number associated with the player; by reading a player tracking card or other smart card inserted into a card reader; by validating a unique player identification number associated with the player by the central server, central controller, or remote host; or by identifying the EGM (or personal gaming device), such as by identifying the MAC address or the IP address of the Internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the Internet browser of the EGM (or personal gaming device). Examples of implementations of Internet-based gaming are further described in U.S. Pat. No. 8,764,566, entitled “Internet Remote Game Server,” and U.S. Pat. No. 8,147,334, entitled “Universal Game Server.”

The central server, central controller, or remote host and the EGM (or personal gaming device) are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs (or personal gaming devices) to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

As should be appreciated by one skilled in the art, aspects of the present disclosure have been illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure have been described herein with reference to flowchart illustrations and/or block diagrams of methods, apparatuses (systems) and computer program products according to embodiments of the disclosure. It should be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

What is claimed is:

1. A system comprising:
a communication network;
a gaming system coupled with the communication network, the gaming system comprising a display device, a processor coupled with the display device, and a memory coupled with and readable by the processor and storing therein a set of instructions which, when executed by the processor, causes the processor to:
present, through the display device, a menu of choices for an electronic game executing on the gaming system, wherein the menu of choices comprises a plurality of selectable options for the electronic game, and wherein each selectable option is associated with a sustainability level,
present, through the display device, a sustainability indicator for the plurality of choices based on the sustainability level associated with each selectable option of the plurality of selectable options,
receive a selection of a player of the electronic game of a selected option of the plurality of selectable options, and
provide, through the communications network, an electronic message identifying the player and the selected option; and
a sustainability monitoring system coupled with the communication network, the sustainability monitoring system comprising a processor and a memory coupled with and readable by the processor of the sustainability monitoring system and storing therein a set of instructions which, when executed by the processor of the sustainability monitoring system, causes the processor of the sustainability monitoring system to:
receive, through the communications network, the electronic message from the gaming system,
update a player sustainability record for the player identified in the electronic message based on the selected option identified in the electronic message,
determine based on the sustainability record for the player, whether to provide a sustainability reward to the player, and
in response to determining to provide the sustainability reward to the player, provide, through the communications network, an electronic message indicating the sustainability reward.

2. The system of claim 1, wherein the plurality of selectable options comprises an option related to a theme for the electronic game.

3. The system of claim 1, wherein the plurality of selectable options comprises an option related to a feature of the electronic game.

4. The system of claim 1, wherein the plurality of selectable options comprises an option related to use of hardware of the gaming system.

5. The system of claim 1, wherein the sustainability reward comprises access to a feature of the electronic game and wherein the instructions stored in the memory of the gaming system further cause the gaming system to:
receive, through the communications network, the electronic message indicating the sustainability reward from the sustainability management system; and
provide, to the player, in the electronic game, access to the feature of the electronic game.

6. The system of claim 1, wherein the instructions stored in the memory of the sustainability management system further cause the processor of the sustainability management system to:
determine, based on the sustainability record for the player, a sustainability level for the player relative to a plurality of players; and
provide, through the communications network, an electronic message indicating the sustainability level for the player; and
wherein the instructions stored in the memory of the gaming system further cause the gaming system to:
receive, through the communications network, the electronic message indicating the sustainability level for the player, and
provide, to the player, through the display device an indication of the sustainability level for the player.

7. The system of claim 1, wherein providing, through the communications network, the electronic message indicating the sustainability reward by the sustainability management system comprise providing the electronic message to a mobile device of the player.

8. A system comprising:
a communication network;
a gaming system of a gaming venue coupled with the communication network, the gaming system comprising a processor and a memory coupled with and readable by the processor and storing therein a set of instructions which, when executed by the processor, causes the processor to:
execute an electronic game,
monitor usage of the gaming system by a player of the electronic game, and
provide, through the communications network, an electronic message identifying the player and the information indicating the usage of the gaming system by the player of the electronic game; and
a sustainability monitoring system coupled with the communication network, the sustainability monitoring system comprising a processor and a memory coupled with and readable by the processor of the sustainability monitoring system and storing therein a set of instructions which, when executed by the processor of the sustainability monitoring system, causes the processor to of the sustainability monitoring system:
receive, through the communications network, the electronic message from the gaming system,
update a player sustainability record for the player identified in the electronic message based on the usage of the gaming system by the player identified in the electronic message,
determine based on the sustainability record for the player, whether to provide a sustainability reward to the player, and
in response to determining to provide the sustainability reward to the player, provide, through the communications network, an electronic message indicating the sustainability reward.

9. The system of claim 8, wherein the system further comprises a restaurant management system comprising a processor and a memory coupled with and readable by the processor of the restaurant management system and storing therein a set of instructions which, when executed by the processor of the restaurant management system, causes the processor of the restaurant management system to:
monitor usage of a restaurant of the gaming venue by the player; and
provide, through the communications network, to the sustainability monitoring system, an electronic message comprising information indicating the usage of the restaurant by the player, wherein the instructions stored in the memory of the sustainability monitoring system further cause the processor of the sustainability monitoring system to update the player sustainability record based on the information indicating the usage of the restaurant by the player.

10. The system of claim 9, wherein the system further comprises a housekeeping management system comprising a processor and a memory coupled with and readable by the processor of the housekeeping management system and storing therein a set of instructions which, when executed by the processor of the housekeeping management system, causes the processor of the housekeeping management system to:
monitor usage of a housekeeping services of a hotel of the gaming venue by the player; and
provide, through the communications network, to the sustainability monitoring system, an electronic message comprising information indicating the usage of the housekeeping services by the player, wherein the instructions stored in the memory of the sustainability monitoring system further cause the processor of the sustainability monitoring system to update the player sustainability record based on the information indicating the usage of the housekeeping service the player.

11. The system of claim 10, wherein the system further comprises a spa system comprising a processor and a memory coupled with and readable by the processor of the spa system and storing therein a set of instructions which, when executed by the processor of the spa system, causes the processor of the spa system to:
monitor usage of services of a of the gaming venue by the player; and
provide, through the communications network, to the sustainability monitoring system, an electronic message comprising information indicating the usage of the services of the spa by the player, wherein the instructions stored in the memory of the sustainability monitoring system further cause the processor of the sustainability monitoring system to update the player sustainability record based on the information indicating the usage of the services of the spa by the player.

12. The system of claim 11, wherein the system further comprises an online gaming system providing online access to the electronic game executed by the gaming system, wherein the online gaming system comprises a processor and a memory coupled with and readable by the processor of the online gaming system and storing therein a set of instructions which, when executed by the processor of the online gaming system, causes the processor of the online gaming system to:
monitor access of the electronic game by the player through the online gaming system; and
provide, through the communications network, to the sustainability monitoring system, an electronic message comprising information indicating the access of the electronic game by the player through the online gaming system, wherein the instructions stored in the memory of the sustainability monitoring system further cause the processor of the sustainability monitoring system to update the player sustainability record based on the information indicating the access of the electronic game by the player through the online gaming system.

13. The system of claim 8, wherein providing, through the communications network, the electronic message indicating the sustainability reward by the sustainability management system comprise providing the electronic message to a mobile device of the player.

14. The system of claim 8, wherein providing, through the communications network, the electronic message indicating the sustainability reward by the sustainability management system comprise providing the electronic message to the gaming system and wherein the instructions stored in the memory of the gaming system further cause the processor of the gaming system to:
receive the electronic message from the sustainability management system through the communications network; and
provide, to the player, through the display device, an indication of the sustainability reward.

15. A gaming system comprising:
a communications interface;
a display device;
a processor coupled with the communications interface and the display device; and
a memory coupled with and readable by the processor and storing therein a set of instructions which, when executed by the processor, causes the processor to:
present, through the display device, a menu of choices for an electronic game executing on the gaming system, wherein the menu of choices comprises a plurality of selectable options for the electronic game, and wherein each selectable option is associated with a sustainability level,
present, through the display device, a sustainability indicator for the plurality of choices based on the sustainability level associated with each selectable option of the plurality of selectable options,
receive a selection of a player of the electronic game of a selected option of the plurality of selectable options,
provide, through the communications network, to a sustainability monitoring system, an electronic message identifying the player and the selected option;
execute the electronic game;
monitor usage of the gaming system by the player of the electronic game, and
provide, through the communications network, to the sustainability monitoring system, an electronic message identifying the player and the information indicating the usage of the gaming system by the player of the electronic game.

16. The gaming system of claim 15, wherein the plurality of selectable options comprises an option related to a theme for the electronic game.

17. The gaming system of claim 15, wherein the plurality of selectable options comprises an option related to a feature of the electronic game.

18. The gaming system of claim 15, wherein the plurality of selectable options comprises an option related to use of hardware of the gaming system.

19. The gaming system of claim 15, wherein the instructions further cause the processor to:
receive, through the communications interface, from the sustainability monitoring system, an electronic message comprising information indicating a sustainability reward for the player based on the selected option and the usage of the gaming system by the player; and
present, through the display device, an indication of the sustainability reward.

20. The gaming system of claim 19, wherein the sustainability reward comprises access to a feature of the electronic game and wherein the instructions stored in the memory of the gaming system further cause the gaming system to provide, to the player, in the electronic game, access to the feature of the electronic game.
